(19) United States
(12) Patent Application Publication
(10) Pub. No.: US 2024/0300049 A1
(43) Pub. Date: Sep. 12, 2024

(54) METHOD AND APPARATUS FOR LASER BUILD-UP WELDING

(71) Applicant: TRUMPF Laser- und Systemtechnik GmbH, Ditzingen (DE)

(72) Inventors: Bjoern Sautter, Leonberg (DE); Nicolai Speker, Pleidelsheim (DE); Alejandro Zamorano Reichold, Passau (DE); Andreas Scholz, Taunusstein (DE); Tim Hesse, Ditzingen (DE)

(21) Appl. No.: 18/667,141

(22) Filed: May 17, 2024

Related U.S. Application Data
(63) Continuation of application No. PCT/EP2022/081490, filed on Nov. 10, 2022.

(30) Foreign Application Priority Data
Nov. 19, 2021 (DE) 10 2021 130 289.7

(51) Int. Cl. B23K 26/06; B22F 12/41; B22F 12/44; B23K 26/342; B33Y 10/00; B33Y 30/00

(52) U.S. Cl. CPC B23K 26/0626; B22F 12/41; B22F 12/44; B23K 26/0648; B23K 26/342; B33Y 10/00; B33Y 30/00

(57) ABSTRACT

A laser build-up welding method includes directing a powdered material and a laser beam onto a workpiece surface of a workpiece at an angle to one another. The powdered material is at least partially heated in an interaction zone with the laser beam above the workpiece surface and is welded onto the workpiece surface along a predefined contour, the laser beam has a wavelength that ranges between 0.4 μm and 1.1 μm. The laser beam within the interaction zone has an intensity in its border region that is greater than an intensity in the core region of the laser beam, so that the powdered material is subjected to the greater intensity of the border region when entering the interaction zone.

### CROSS REFERENCE TO RELATED APPLICATIONS

This application is a continuation of International Application No. PCT/EP2022/081490 (WO 2023/088779 A1), filed on Nov. 10, 2022, and claims benefit to German Patent Application No. DE 10 2021 130 289.7, filed on Nov. 19, 2021. The aforementioned applications are hereby incorporated by reference herein.

### FIELD

Embodiments of the present invention relate to the field of laser build-up welding.

### BACKGROUND

Methods for laser build-up welding are known in principle from the prior art. They are used primarily in the fields of repair techniques, coating techniques and connecting techniques. In the case of laser build-up welding, a distinction can be made between conventional laser build-up welding (also laser metal deposition or LMD method, direct metal deposition (DMD) or direct energy deposition (DED)) and what is referred to as high-speed laser build-up welding (also HS-LMD or extreme high-speed laser application (EHLA)).

In the case of conventional laser build-up welding, a melt pool 16 is generated on the surface 12 of a workpiece 10 by means of a laser beam 30, as schematically illustrated in FIG. 1a. A powdered filler material 20 is introduced into the melt pool 16 through a powder nozzle arranged coaxially with or laterally in relation to the laser beam 30 by way of an inert conveying or carrier gas. Before impinging on the melt pool 16, the powder particles 20, or at least some of the powder particles 20, are subjected to laser light in an interaction zone 40 with the laser beam 30. In the case of LMD methods, the input of energy into the workpiece 10 by means of the laser beam 30 is generally greater than the input of energy into the powder particles 20. The powder particles 20 are therefore generally only melted after impinging in the melt pool 16. If the melt solidifies, a consolidated layer bonded by melt metallurgy is formed. A coaxial powder-nozzle arrangement generates a focused powder/gas jet. In order to create a defect-free layer, in principle the interaction time with the powder particles 20 in the melt pool 16 needs to be long enough to enable temperature equalization to take place between the particles 20 and the melt 16 and the particles 20 to transition to the liquid state. This limits the speed of the LMD process. The large amount of laser radiation impinging on the workpiece results in the production of a large mixing and heat affected zone 14 (WEZ).

By contrast to the conventional LMD process, in the case of HS-LMD (cf. FIG. 1b) the powdered filler material 20 is deliberately heated to temperatures around the melting point or higher above the workpiece surface 12. Owing to a sufficiently large interaction zone 40 between the laser beam 30 and the powder/gas jet, the powder 20 is heated to such an extent that it substantially directly forms a solid, in particular melt-metallurgical connection with the workpiece 10 on the workpiece surface 12, which is likewise preheated by the laser beam 10. This makes it possible to realize considerably higher feed rates, up to 500 m/min, than in the case of conventional laser build-up welding (0.5 m/min to 2 m/min), since there is no need to spend time on melting the particles 20 in the melt pool 16. Reducing the input of energy into the workpiece 10 causes a considerable reduction in the heat affected zone 14 and the mixing region 16. This also makes it possible to coat temperature-sensitive materials such as aluminum and cast alloys by means of HS-LMD.

HS-LMD methods are described, for example, in DE 10 2011 100 456 B4 or in DE 10 2018 130 798 A1.

HS-LMD is used for the coating of in particular rotationally symmetrical components, for example brake disks. For the material build-up by means of HS-LMD, the component is rotated and the processing head for supplying the laser beam and the powder is moved in particular in a straight line perpendicularly or parallel to the axis of rotation of the component. In this way, a spiral-shaped or helical bead, which forms a coating face at the end, can be created.

The known laser build-up welding methods and in particular conventional HS-LMD methods have the disadvantage that even small changes to process parameters can lead to considerable fluctuations in the welding result. For example, a change of the laser power and/or the beam intensity on the workpiece, which can be caused for example by contamination of the optical unit or a focus shift, can be accompanied by sensitive losses in the quality of the welding result.

### SUMMARY

Embodiments of the present invention provide a laser build-up welding method. The method includes directing a powdered material and a laser beam onto a workpiece surface of a workpiece at an angle to one another. The powdered material is at least partially heated in an interaction zone with the laser beam above the workpiece surface and is welded onto the workpiece surface along a predefined contour. The laser beam has a wavelength that ranges between 0.4 μm and 1.1 μm. The laser beam within the interaction zone has an intensity in its border region that is greater than an intensity in the core region of the laser beam, so that the powdered material is subjected to the greater intensity of the border region when entering the interaction zone.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows a schematic illustration of a laser metal deposition (LMD) process;

FIG. 1b shows a schematic illustration of a high-speed LMD (HS-LMD) process;

FIGS. 2a-d show schematic illustrations of the different interaction sections of a powdered filler material with a laser beam during laser build-up welding, the laser beam within the interaction zone having a different intensity distribution in each case, according to some embodiments;

FIG. 3 shows, by way of example, the process window width with respect to the laser power depending on the beam profile of the laser beam, according to some embodiments;

FIG. 4a schematically shows a beam profile with an annular intensity maximum according to some embodiments; and

FIG. 4b schematically shows a linear beam profile with a leading and a trailing intensity maximum according to some embodiments.

### DETAILED DESCRIPTION

Embodiments of the present invention provide improvements to the laser build-up welding process. In particular, embodiments of the present intention can increase the process stability and/or the process reliability by widening the process window in the case of the LMD process and in particular in the case of the HS-LMD process. Embodiments of the present intention can also improve the surface roughness in the case of laser build-up welding and/or reduce the tendency to crack.

Embodiments of the invention provide a laser build-up welding method in which powdered material and a laser beam are directed onto a workpiece surface of a workpiece at an angle to one another, with the result that the powdered material is at least partially heated in an interaction zone with the laser beam above the workpiece surface and is welded onto the workpiece surface along a predefined contour.

The workpiece can preferably be a metallic workpiece. The powdered material can in particular be a metallic material. The powder is radiated onto the workpiece surface by means of a conveying gas, in particular argon or helium, or by means of an inert gas mixture. The focus of the laser beam can preferably lie on the workpiece surface or above the workpiece surface. The powder can be focused toward the workpiece surface preferably by means of an annular nozzle (annular die) or by means of multiple nozzles arranged annularly around the laser beam (multi-jet nozzle). As an alternative, for example, wide-jet nozzles for generating a line powder focus can be used. In this case, the powder can be radiated onto the processing location for example obliquely from the front and/or obliquely from the rear (with respect to the feed direction). The focus of the powder jet can in principle lie both on the workpiece surface and above or below it. In particular, if material is to be deposited in HS-LMD mode, the focus of the powder jet can preferably lie above the workpiece surface. The powder focus can have, for example, a diameter of between 0.2 mm and approximately 6 mm. In addition to the conveying gas, an inert gas in a process shielding gas jet can be directed onto the processing location coaxially with or laterally to the laser beam. The process shielding gas can additionally shield the processing location from the surrounding atmosphere. In particular in the case of coating by means of a HS-LMD method, the workpiece can be for example a brake disk, a hydraulic cylinder, a printing roller or another rotationally symmetrical workpiece.

The laser beam has a wavelength which ranges between 0.4 μm and 1.1 μm. With preference, the laser beam can be provided such that it can be guided to the processing head by means of an optical fiber. For example, the laser beam can have a wavelength of approximately 450 nm, of approximately 515 nm, between approximately 800 nm and approximately 1000 nm, or of approximately 1030 nm, 1060 nm or 1070 nm.

Within the interaction zone, the laser beam also has an intensity in its border region which is higher than an intensity in the core region of the laser beam, so that the powdered material is subjected to the higher intensity of the border region when it enters the interaction zone. The described beam profile of the laser beam does not have to be present over the entire length of the interaction zone. However, it needs to be present at least at one location in the interaction zone. For example, the beam profile of the laser beam may be present in the region of the focal plane of the laser beam, if the laser beam focus lies within the interaction zone.

The inventors have found that an inconsistent interaction time of the powder particles of the filler material with the laser beam, which is to say an uneven distribution of the fluence per powder particle, has a negative influence on the process reliability. The oblique alignment of the laser beam and of the powder jet (or of the powder jets) relative to one another as a result of the process causes the interaction section with the laser beam to vary over the cross section of the powder jet. Therefore, what is important is not only the level of the laser intensity in the case of the LMD method and in particular in the case of the HS-LMD method, but also the spatial laser intensity distribution in the laser beam. The prior art makes use of beam profiles with a Gaussian (Gaussian-profile) or plateau-shaped (what is referred to as top hat-profile) intensity distribution. Primarily in the case of a Gaussian intensity distribution, the powder particles exhibit a large temperature gradient.

An intensity maximum in the border region of the laser beam leads to a more even distribution of the fluence per powder particle and thus to an enlargement of the process window through to higher laser powers together with a more stable welding quality.

According to one variant, the laser beam within the interaction zone can have a beam profile with a substantially annular intensity maximum. The wording “substantially annular intensity maximum” is to be understood as meaning that the beam profile of the laser beam has a border region which encloses the central core region of the laser beam and in which the laser beam, preferably at any location, has a higher intensity than in the core region. With preference, the laser beam within the interaction zone can have a circular core region and an annular border region which encloses the core region and in which the intensity of the laser beam is higher than in the core region. The border region can also have multiple ring regions, the intensity of the laser beam within the interaction zone being higher at least in one of the ring regions than in the core region. The intensity profile can have both a graduated and a continuous form at the transitions between the regions. The intensity of the laser beam along the annular intensity maximum can preferably be approximately the same. As an alternative, the intensity of the laser beam along the annular intensity maximum can be variable and different and fluctuate, for example, by up to approximately 30%. In the case of a laser beam with an annular intensity maximum, it may be provided that the powdered filler material is supplied to the processing location coaxially with the laser beam, for example by means of an annular die or a multi-jet nozzle.

According to an alternative variant, the laser beam within the interaction zone can have a linear beam profile which is aligned substantially transversely to the feed direction of the laser beam and has a leading intensity maximum in the feed direction and/or a trailing intensity maximum in the feed direction. The feed direction means the direction in which the laser beam is moved relative to the workpiece surface. In the case of high-speed laser build-up welding (HS-LMD), a relatively fast feed rate of the workpiece, in particular in rotation, can have a relatively slow, lateral feed rate of the processing head that guides the laser beam superposed on it. In this case, the laser beam with a linear beam profile can also be aligned perpendicularly to the rotational movement of the workpiece, which is to say-depending on the feed rate of the processing head—not completely perpendicularly to the resulting feed direction. In the case of a laser beam with a linear beam profile, the leading intensity maximum and the trailing intensity maximum each extend linearly substantially transversely to the feed direction and are spaced from one another by the likewise linear region of lower intensity (core region of the laser beam). According to this variant, it may also be provided that the powdered filler material is directed onto the workpiece location obliquely from the front and/or obliquely from the rear by means of one or more wide-jet nozzles, which are aligned substantially parallel to the linear laser focus.

It should be understood that the laser beam may also be composed of multiple separate laser beams, which are at least partially superposed in the focal plane.

According to a preferred variant, a feed rate of the laser beam and of the powder jet or of the powder jets relative to the workpiece may be more than 20 m/min. It may be provided that the focus of the powder jet or of the powder jets lies above the workpiece surface in the interaction zone with the laser beam. To realize feed rates beyond 20 m/min, it is possible to provide in particular a simultaneous movement of the workpiece and of the laser processing head. For example, the component may be a rotationally symmetrical component which is rotated, the processing head being guided in a linear movement perpendicular or parallel to the axis of rotation of the workpiece, in order to create a spiral-shaped or helical material deposition on the workpiece surface.

According to one variant, an intensity distribution in the border region of the laser beam may be substantially plateau-shaped. The plateau shape may also be referred to as a top hat. The plateau- or top hat-shaped intensity distribution describes a sudden rise in the intensity at the border of the laser beam to the intensity maximum, which is maintained substantially over the entire width of the border region, before the intensity suddenly drops back again in the direction toward the core region of the laser beam. The plateau- or top hat-shaped intensity distribution in the border region of the laser beam promotes a reduction in the roughness of the deposited material layer compared to a Gaussian intensity distribution.

Overall, for the intensity distribution of the laser beam in the focal plane, it can hold true that: I_{border}≥ I_{center}≥0.

At least at one location within the interaction zone, the intensity in the core region of the laser beam may be at most 90%, preferably at most 50%, even more preferably at most 10% of the intensity maximum in the border region of the laser beam. The intensity distribution with a reduced intensity in the core region of the laser beam makes it possible to enlarge the process window with regard to the variability of the laser power used. In particular, with the described intensity distribution in the focal plane, it is possible to use higher laser powers (in particular >4 kW) compared to the prior art, while still maintaining the welding quality. It is thus possible to expend more laser power to preheat and/or melt the powder for the coating of the workpiece.

The laser beam may comprise a core beam and a ring beam. In this case, an outside diameter of the ring beam at least at one location within the interaction zone may be at most 10 times, preferably at most 5 times, even more preferably at most 4 times the diameter of the core beam. In other words, the ratio of the diameter of the core portion to the diameter of the ring portion may be greater than 1:10, preferably greater than 1:5, even more preferably greater than 1:4. The limits of the respective beam proportions may be determinable, for example, using the 2nd moment method. The narrower the border region of the laser beam is, the more even the temperature distribution among the powder particles becomes, since the differences in the interaction time with the laser beam are reduced.

At least at one location within the interaction zone, the power in the core region of the laser beam can be, for example, between 7% and 9% of the laser power of the overall laser beam. It can be advantageous if the power in the core region is between 5% and 7%, in particular approximately 6% of the overall power of the laser beam. In such a variant, the process reliability (and therefore the process window) can be increased by approximately 25%, with about the same degree of energy efficiency, in comparison with a conventional laser build-up welding method with a top-hat beam profile. According to an alternative variant, the power in the core region can be reduced to a minimum, which is to say amount in particular to 0% of the overall laser power. In this case, the process reliability can be increased by approximately 35% in comparison with a conventional laser build-up welding method with a top-hat beam profile.

The outside diameter of the laser beam, in particular the outside diameter of the ring beam according to the variant described above, can be at least 500 μm, preferably at least 1000 μm, even more preferably at least 2000 μm at least at one location in the interaction zone. By enlarging the laser beam diameter in the interaction zone, in particular on the workpiece surface, the productivity of the method can be increased. In the case of the HS-LMD method, trace widths, i.e. outside diameters, of ≥1000 μm can be preferred.

To create the beam profile of the laser beam with a core region and a border region, a multi-clad fiber, in particular a 2-in-1 fiber, can be used. Such fibers are known from the prior art and described, for example, in WO 2011/124671 A1. Laser radiation can be variably input-coupled into the core fiber and/or into the ring fiber and conducted to a focusing optical unit from one or more beam generators. The use of a 2-in-1 fiber makes it possible to use straightforward focusing optical units without further optical beam-shaping elements, and thus efficient beam shaping. The intensity proportions in the core region and the ring region of the laser beam can be controlled easily. For example, it is possible to use a 2-in-1 optical fiber with a core diameter of between 200 μm and 300 μm and a ring outside diameter of between 700 μm and 1000 μm with an adjusting device (for example a wedge beam switch) to set the core/ring power ratio.

It should be understood that a multi-clad fiber with more than one ring fiber portion can also be used, for example to create a beam profile with different intensities in the different ring regions.

The power proportion in the ring fiber and the core fiber can be variable by means of a suitable controller. The decreased intensity in the core region of the laser beam can thus be adapted to the (HS-)LMD process and/or to the workpiece.

In addition or alternatively, it is also possible to use beam-shaping elements, in particular a diffractive optical element (DOE) or a multi-lens array, to create the beam profile described. In this way, non-rotationally symmetrical beam profiles, for example a linear beam profile, can also be created. Furthermore, an annular beam profile can also be created in this way using a single-core fiber.

The imaging scale can preferably be variable independently in any of the variants described above. In this way, the focal diameter of the laser beam can be individually adapted to the welding task.

The laser beam source (or beam generator) used can be a disk laser or a fiber laser. In this way, for example, laser beams with wavelengths of approximately 1.06 μm or approximately 500 nm can be generated. Disk lasers and fiber lasers are suitable for the creation of small ring and core diameters, and for the use of beam-shaping elements. To use the method described above, it is possible to use, for example, a fiber laser or disk laser with a laser power of more than 2 kW to 8 KW and above, for example to 12 kW or more.

The laser beam source used can also be, for example, a diode laser. As a result of the large fiber diameters that can be used, the laser beam can still be readily input-coupled into the comparatively large ring and core portions of a multi-clad fiber in spite of the limited brilliance of the diode emitter/bar/stack.

Embodiments of the present invention also provide a laser build-up welding apparatus. The apparatus comprises at least one laser beam unit for providing a laser beam, which has an intensity in a border region which is greater than an intensity in the core region of the laser beam; a powder supply unit for providing powdered material; and a control unit, which is designed to activate the apparatus to carry out a method according to one of the variants described above.

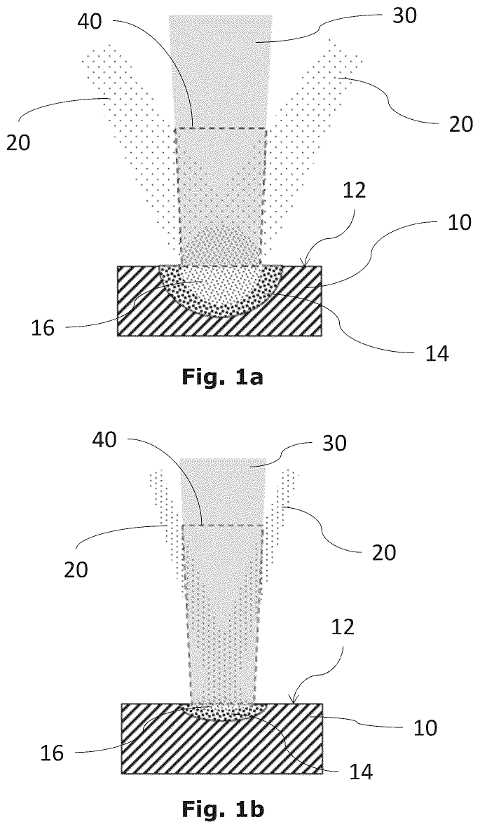

FIGS. 1a and 1b were already described above in connection with the prior art. Reference is made to the explanations given there.

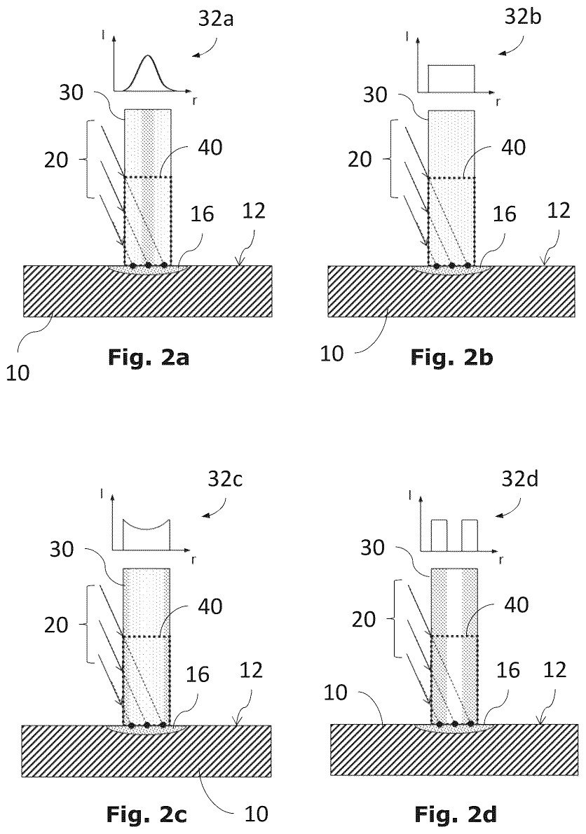

The influence of the intensity distribution of the laser beam on the interaction with the powdered filler material during laser build-up welding will be explained in more detail below with reference to FIGS. 2a to 2d.

FIGS. 2a to 2d schematically show a sectional front view of a workpiece 10, which is locally melted by means of a laser beam 30 for laser build-up welding, with the result that a melt pool 16 is produced on the workpiece surface 12. While the laser beam 30 is being moved over the workpiece 10 perpendicularly to the plane of the drawing, a filler material in the form of a powder jet 20 is radiated onto the processing location by means of a preferably inert conveying gas. FIGS. 2a-d each illustrate only the application of powder from one side for the sake of simplicity. However, it should be understood that, in the case of powder build-up welding, the filler material can be directed onto the processing location in multiple individual beams arranged annularly around the laser beam or in the form of an annular jet, and in the case of a linear beam profile of the laser beam for example from the front and/or from the rear in the form of a linear powder jet.

Depending on the position of a powder particle within the powder jet 20, the interaction section within an interaction zone 40 along which the relevant powder particle is subjected to the laser radiation has different lengths. Correspondingly, depending on their trajectory, the powder particles are heated to different extents by the laser beam 30. While powder particles in the center of the powder jet 20 are being melted within the interaction zone 40 for example, it is possible at the same time for powder particles in the border region of the powder jet 20 to be evaporated owing to having longer or shorter interaction times with the laser beam 30 (cf. powder particles on the right or at the top in FIGS. 2a-d) or to impinge on the workpiece surface 12 in the solid state (cf. powder particles on the left or at the bottom in FIGS. 2a-d). The temperature gradient of the powder particles during laser build-up welding is great if the laser beam 30 has a Gaussian intensity profile 32a within the interaction zone 40. This case is illustrated in FIG. 2a. Powder particles at the outer (or bottom) border of the powder jet 20 are heated weakly.

The inconsistent interaction time of the powder particles with the laser beam 30 has a negative influence on the welding result. A high-quality weld bead can thus be ensured only in a narrow process window with process parameters that are precisely matched to one another. Changes to the laser power can already lead to sensitive quality fluctuations in the welding result.

An improvement in the temperature gradient and/or a narrower temperature bandwidth of the powder particles can be achieved if a laser beam 30 with a plateau- and/or top hat-shaped intensity profile 32b is used, as illustrated in FIG. 2b.

The powder can also be heated more uniformly if use is made of a laser beam 30 which, within the interaction zone 40, has an intensity distribution 32c, 32d according to FIG. 2c or 2d. FIG. 2c illustrates a laser beam 30 with a concave intensity profile 32c in the interaction zone 40, in the case of which the intensity drops from an annular maximum toward the core region of the laser beam 30. Owing to the high intensity in the border region of the laser beam 30, powder particles having a short interaction time are also still heated comparatively strongly.

A uniform temperature distribution of the powder particles can be achieved for a coaxial powder supply with an annular intensity profile of the laser beam 30, in the case of which most of the laser energy is present in the border region of the laser beam 30. A plateau-like and/or top hat-shaped intensity distribution 32d in the annular outer region of the laser beam 30 (cf. FIG. 2d) has been found to be favorable in this case. The use of a laser beam 30 with such an intensity distribution makes it possible to advantageously influence the process stability, in particular in the case of high-speed laser build-up welding.

FIGS. 2c and 2d each relate to variants in which the laser beam 30 has a rotationally symmetrical cross section. It should be understood that the illustrations in FIGS. 2c and 2d can be applied analogously to a laser beam 30 with a linear beam profile, the respective intensity distribution 32c, 32d then only being present transversely to the length of the linear beam profile.

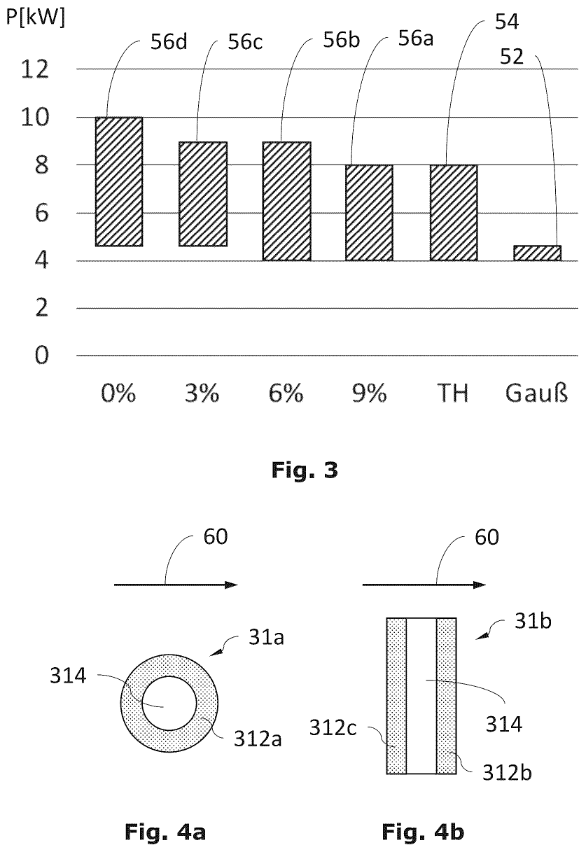

FIG. 3 shows, by way of example, the change to the process window in the case of high-speed laser build-up welding depending on the beam profile of the laser beam used. The laser powers in kW, by means of which the process can be carried out without significant losses in quality in the welding result given process parameters that are otherwise the same, are plotted in the vertical direction. The illustration relates to high-speed laser build-up welding on a tubular workpiece made of construction steel, the outside diameter of the laser beam in the focal plane being 2000 μm and the feed rate being approximately 80 m/min.

When a laser beam with a Gaussian beam profile (cf. FIG. 2a), i.e. with a Gaussian intensity distribution of the laser beam in the focal plane, is used, an acceptable welding result can only be achieved in a very narrow power range of 4 kW to about 4.6 kW. The process window 52 is thus very small.

In the case of a laser beam with an intensity distribution that is top hat-shaped over its entire cross section within the interaction zone (cf. FIG. 2b), the process window 54 is already considerably larger. For the process, it is possible to use laser powers of between 4 kW and 8 KW without significant losses in quality in the welding result.

The process windows 56a to 56d each relate to the use of a laser beam with an annular beam profile having a top hat-shaped intensity distribution in the annular border region of the laser beam and having a different laser power in the core region of the laser beam.

In the case of a core power of 9% of the overall laser power, the process window 56a corresponds substantially to the process window 54 with a top hat-shaped intensity profile according to the illustration in FIG. 2b. In the event of a relative reduction in the laser power in the core region of the laser beam to 6% of the overall power, the laser power can be increased to 9 KW while maintaining a good welding quality. This corresponds to an enlargement of the process window 56b by 25% compared to the process window 54 with a top hat-shaped intensity profile without an annular power or intensity distribution. When the core power is reduced further to 3% of the overall power of the laser beam, losses in the degree of energy efficiency of the method can be identified. This means that good welding results can only be achieved above a laser power of approximately 4.6 kW. However, the laser powers that can be utilized with the process window 56c are 10% greater than those that can be utilized with the process window 54 when a normal laser beam with a top-hat beam profile is used. According to the illustration in FIG. 3, the largest possible process window 56d can be achieved with an annular beam profile, with all of the laser power being present in the ring portion, which is to say the laser power in the core beam is lowered to zero (cf. also FIG. 2d). With this beam profile, high-quality welding results can be achieved between 4.6 kW and 10 KW. This corresponds to an enlargement of the process window by 35% compared to the process window 54 when a conventional top-hat beam profile is used.

The comparison according to FIG. 3 shows that the process window can be opened up to higher laser powers in the case of high-speed laser build-up welding using a laser beam with an annular intensity maximum and with coaxial supply of the powdered filler material in the beam focus. The findings from FIG. 3 can be transferred analogously to a laser beam with a line focus, which has a respective linear intensity maximum at its front and rear border in the feed direction within the interaction zone, the powdered filler material being directed onto the processing location only from the front and from the rear in a linear powder jet oriented in each case substantially transversely to the feed direction.

FIGS. 4a and 4b illustrate different beam profiles 31a, 31b of a laser beam 30 which respectively have a core region 314 and a border region 312a, 312b, 312c. According to embodiments of the invention, the illustrated beam profiles 31a, 31b can be in a projection plane which extends transversely to the propagation direction of the laser beam 30 and lies within the interaction zone 40 (cf. FIGS. 1 and 2). The laser beam 30 according to FIG. 4a has a circular intensity maximum in its annular border region 312a and a core region 314 with an intensity lower than that of the border region 312 (cf. also FIG. 2d). FIG. 4b shows a linear beam profile 31b of a laser beam 30 aligned transversely to the feed direction 60. The laser beam 30 according to FIG. 4b has a leading intensity maximum in its front border region 312b in the feed direction 60 and a trailing intensity maximum in its rear border region 312c. The core region 314 of the laser beam 30 is arranged between the straight intensity maxima and is likewise straight.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Workpiece
12 Workpiece surface
14 Heat affected zone
16 Melt pool
20 Powder jet (filler material)
30 Laser beam
31a Annular beam profile
31b Linear beam profile
312a Annular border region
312b Front border region
312c Rear border region
314 Core region
32a Gaussian intensity distribution of the laser beam
32b Top-hat intensity distribution of the laser beam
32c Concave intensity distribution of the laser beam
32d Annular top-hat intensity distribution of the laser beam
40 Interaction zone
52 Process window-Gaussian intensity profile
54 Process window-Top-hat intensity profile
56a Process window-annular top-hat intensity profile with 9% core power
56b Process window-annular top-hat intensity profile with 6% core power
56c Process window-annular top-hat intensity profile with 3% core power
56d Process window-annular top-hat intensity profile with 0% core power
60 Feed direction

1. A laser build-up welding method, the method comprising:
directing a powdered material and a laser beam onto a workpiece surface of a workpiece at an angle to one another, wherein the powdered material is at least partially heated in an interaction zone with the laser beam above the workpiece surface and is welded onto the workpiece surface along a predefined contour;
wherein the laser beam has a wavelength that ranges between 0.4 μm and 1.1 μm; and
wherein the laser beam within the interaction zone has an intensity in its border region that is greater than an intensity in the core region of the laser beam, so that the powdered material is subjected to the greater intensity of the border region when entering the interaction zone.

2. The method as claimed in claim 1, wherein the laser beam within the interaction zone has a beam profile with a substantially annular intensity maximum, and wherein the powdered material is directed onto the workpiece surface coaxially with the laser beam.

3. The method as claimed in claim 1, wherein the laser beam within the interaction zone has a linear beam profile, which is aligned substantially transversely to a feed direction of the laser beam and has a leading intensity maximum in the feed direction and/or a trailing intensity maximum in the feed direction, and wherein the powdered material is directed onto the workpiece surface in one or more linear powder jets from a front and/or from a rear.

4. The method as claimed in claim 3, wherein a feed rate of the laser beam and of the powder jet relative to the workpiece surface is more than 20 m/min.

5. The method as claimed in claim 1, wherein an intensity distribution in the border region of the laser beam is substantially plateau-shaped.

6. The method as claimed in claim 1, wherein the intensity in the core region of the laser beam within the interaction zone is at most 50% of the intensity in the border region of the laser beam.

7. The method as claimed in claim 6, wherein the intensity in the core region of the laser beam within the interaction zone is at most 10% of the intensity in the border region of the laser beam.

8. The method as claimed in claim 1, wherein the laser beam comprises a core beam and a ring beam; and
wherein an outside diameter of the ring beam within the interaction zone is at most 5 times of an diameter of the core beam.

9. The method as claimed in claim 8, wherein the outside diameter of the ring beam within the interaction zone is at least 1000 μm.

10. The method as claimed in claim 9, wherein the outside diameter of the ring beam within the interaction zone is at least 2000 μm.

11. The method as claimed in claim 1, wherein a multi-clad fiber is used to create a beam profile of the laser beam.

12. The method as claimed in claim 9, wherein the multi-clad fiber is a 2-in-1 fiber.

13. The method as claimed in claim 1, wherein a beam-shaping element is used to create a beam profile of the laser beam.

14. The method as claimed in claim 13, wherein the beam-shaping element comprises a diffractive optical element (DOE) or a multi-lens array.

15. The method as claimed in claim 1, wherein a disk laser or a fiber laser is used as a laser beam source.

16. The method as claimed in claim 1, wherein a diode laser is used as a laser beam source.

17. A laser build-up welding apparatus comprising:
a laser beam source for providing a laser beam, wherein the laser beam has an intensity in a border region that is greater than an intensity in a core region of the laser beam;
a powder supply for providing a powdered material; and
a controller configured to activate the laser build-up apparatus to carry out a method as claimed in claim 1.
